(19) United States
(12) Patent Application Publication
(10) Pub. No.: US 2011/0080638 A1
(43) Pub. Date: Apr. 7, 2011

(54) Microscope

(76) Inventor: Dieter FEGER, Wien (AT)

(21) Appl. No.: 12/588,155

(22) Filed: Oct. 6, 2009

(51) Int. Cl. G02B 21/24; G02B 21/06

(52) U.S. Cl. 359/385; 359/390

(57) ABSTRACT

A microscope includes a microscope basis for placing the microscope onto a surface, e.g. of a working table, a microscope pillar, which stands on the basis and extends substantially in upright direction, a support arm on the pillar, which projects from it and can be adjusted in height from the basis and supports an optical or opto-electrical observing system. The support arm has substantially light-tight walls, which surround at least one cavity. This cavity is located between the optical system and a region that is at least near the microscope pillar. In at least one embodiment, the at least one component is located within the cavity and includes an internal light source. There is a plug-in and holding system for the energy guide, which is either light energy and/or electrical energy.

### FIELD OF THE INVENTION

The present invention relates to a microscope comprising a microscope basis for placing the microscope onto a surface, e.g. of a working table, a microscope pillar, which stands on the basis and extends substantially in upright direction, a support arm on the pillar, which projects from it and can be adjusted in height from the basis and supports an optical or opto-electrical observing system. Such opto-electrical observing system may include a video-camera. Furthermore, there is an electric illumination system.

### BACKGROUND OF THE INVENTION

For illuminating, it is known to have an electrical light source separated from the microscope, whose light illuminates an object to be observed via one or more light guides. The respective light exit surface of the light guide can directly face the object, or it may be connected to a fiber-optical ring light arranged around the optical observing system.

Such illumination systems have the advantage that most different variations of object illumination can be effected, but they have the great disadvantage that a separate light source is much space consuming on a working table and the location where such light source stands must be near the microscope, because light guides of a considerable length are expensive. Furthermore, the limited mechanical flexibility of a light guide has to be taken into account so that a free choice for that location is not given, which is also disadvantageous.

In DE 10 2005 036 230, it has been suggested to integrate light diodes into a microscope, so that the disadvantages of a separate light source are avoided. Light diodes, in comparison with halogen lamps, are very small and, in addition, the current consumption is substantially smaller. In this way, the combination of such illumination device with a microscope can be effected, without altering or increasing essentially the shape, the volume or the weight of the microscope. This known proposal provides that several light-diodes on a focusing or supporting arm for the optical system. These light-diodes rigidly oriented in a predetermined direction for providing an epi-illumination. Therefore, a user, in a disadvantageous manner, is unable to vary the illumination of an object, although such variation is required for many investigations.

Furthermore, it has been suggested in U.S. Patent Application No. 2004/263960 A1 to arrange a light projector having several light-diodes between the objective and the microscope pillar, the projector being inclined to the optical axis of the observation system so as to be oriented towards the object to be investigated. Changing the direction of the projector's beam, in a disadvantageous manner, is only possible in a very limited area. Energy supply is effected through an electric cable which extends from a supply unit in the basis of the microscope to the light-diodes. It is a disadvantage that this cable passes the interior of the microscope pillar which increases mounting expenses for the microscope, on the one hand, and involves the risk that with a displacement of the optical system the cable will be worn or damaged.

U.S. Pat. No. 5,920,425 teaches a video-microscope which can also be formed as a video-presentation system. For illuminating an object an illumination device is incorporated in a head unit, where the video-camera too is accommodated. Furthermore, it is suggested to secure the illumination device to the video-microscope.

U.S. Pat. No. 3,971,621 discloses a microscope where a light guide is provided for object illumination. This light guide is coupled to a light source which is externally attached to the microscope stand. The light-guide is directed to the object to be investigated from below.

EP-1 469 333 A1 shows a microscope equipped with two light guides which are positioned towards the object to be investigated.

### SUMMARY OF THE INVENTION

It is, therefore, an object of the present invention to combine an illumination unit with a microscope and to provide a constructional unit in such a way that the disadvantages of known constructions are avoided, on the one hand, and a variation of the object illumination is made possible, on the other hand, as it is possible with separated light sources.

According to the invention, it is, therefore, suggested that the support arm for the optical system comprises at least one cavity surrounded by light-tight walls. This cavity is arranged either between the optical system and the microscope pillar, or on the side behind the microscope pillar at that end which is opposed to the end of the support arm which bears the observation system, or it is laterally situated with respect to the microscope pillar. The cavity houses electrical or electronic and/or or light emitting components (herein below generally called “component operated by electric current”) of the illumination device, a mechanical plug-in and holding system being arranged on the support arm either for an electric connection of an external light source, e.g. at least one light-diode, situated outside the support arm, which is to be oriented towards the object to be investigated, and/or for a light guide from an internal light source in the cavity to illuminate the object.

The design according to the present invention enable integrating at least all important components of an electric light source for epi-illumination of an object under investigation within a microscope. Through the connection either of one or more light guides, particularly flexible, fiber-optical light guides, or of external projectors, particularly comprising light-diodes, or of a fiber-optical ring light, or of a ring light comprising light-diodes, a waste variety of illumination possibilities are made possible without the use of long and expensive light guides which would, in addition, affect the free space for operating. Generally spoken, a very compact microscope is, thus, created having an at least partially integrated illumination system, which is simple in operation, in transport and placement.

According to another characteristic of the invention resides in that the respective component operated by electric current is formed as an exchangeable module, preferably in one piece. It is preferred that the cavity is closed by a releasable cover, i.e. a pivotal flap or a displaceable slider, which enables an access to the component(s) in the cavity. In this way, it is possible to replace the respective component in the cavity for another one so as to change some parameters of the illumination, such as color temperature or light intensity to adapt it to the necessities of an investigation to be effected. Of course, the component can also easily be exchanged in the case of failure.

Of course, it is also possible to have a housing attached to the focusing support arm, in the cavity of which a large sized component of an illumination system is accommodated, such as a power transformer, a cooling fan, without changing the basic configuration of the microscope.

According to a further characteristic of the invention at least two cavities are provided, one cavity housing at least one internal light source, whereas the other cavity houses en electric component. This has the advantage that heat, generated by a light emitting component, is kept off electric or electronic components so that service life of them is increased. Moreover, this arrangement of cavities results in a better utilization of the volume of the support arm so that its dimensions may be kept small, which leads also to a lower weight.

However, in order to ensure a simple way for electric interconnection between the components, it is advantageous, if at least one channel is provided between the at least two cavities. This channel houses at least one electrical conductor for interconnecting components in the cavities.

Since objects to be investigated are often sensitive to heat, it is preferred if the cavity is remote from the optical system.

Radiation of heat, in accordance with a further characteristic of the invention, be reduced by a thermal insulation for insulating the wall(s) of the cavity.

Heat transfer to the support arm for the optical system can also be reduced in accordance with a further embodiment of the invention, if a cavity or each cavity, where a light emitting component is, comprises at least one ventilation aperture or a similar opening. Suitably, there is at least one covering lamella for shielding this ventilation aperture against any passage of light from the internal light source, but enabling the escape of heat from the cavity.

It is, thus, one of the objects of the invention to prevent any heat transfer to the object or to the support arm, and to reach this object, it is suggested according to the invention that the cavity comprises at least one Peltier element for reducing heat transfer to the incorporated electric, electronic and/or light emitting elements. In this way, it is possible to cool light diodes, which with a normal air cooling equipment are operated at about 40° C., down to about 20° C., a temperature, which corresponds about to the usual ambient temperature in a laboratory.

### BRIEF DESCRIPTION OF THE DRAWINGS

Further advantages and details will become apparent by the following description of some embodiment of the invention schematically shown in the drawings, in which

FIG. 1 is a lateral view of a first embodiment of a microscope comprising a support arm for the observation system which has a cavity and a light-diode in it, whose light beam is directed to a fiber light guide;

FIG. 2 is a lateral view of a second embodiment of a microscope comprising a cavity in the support arm, which houses a light-diode, a cooling body and an electronic control unit, while the light is guided through a light guide to a fiber-optic ring light;

FIG. 3 is a perspective view of a third embodiment of a microscope, which comprises a ring light equipped with a plurality of light-diodes;

FIG. 4 is a plan view of a fourth embodiment showing a stereo-microscope, whose support arm is illustrated in cross-section and has three cavities for receiving and holding components of an illumination system;

FIG. 5 shows part of a support arm in a cross-sectional view and representing in particular a plug-in and holding system for connecting a light diode, electric power and a light guide.

### DETAILED DESCRIPTION OF THE DRAWINGS

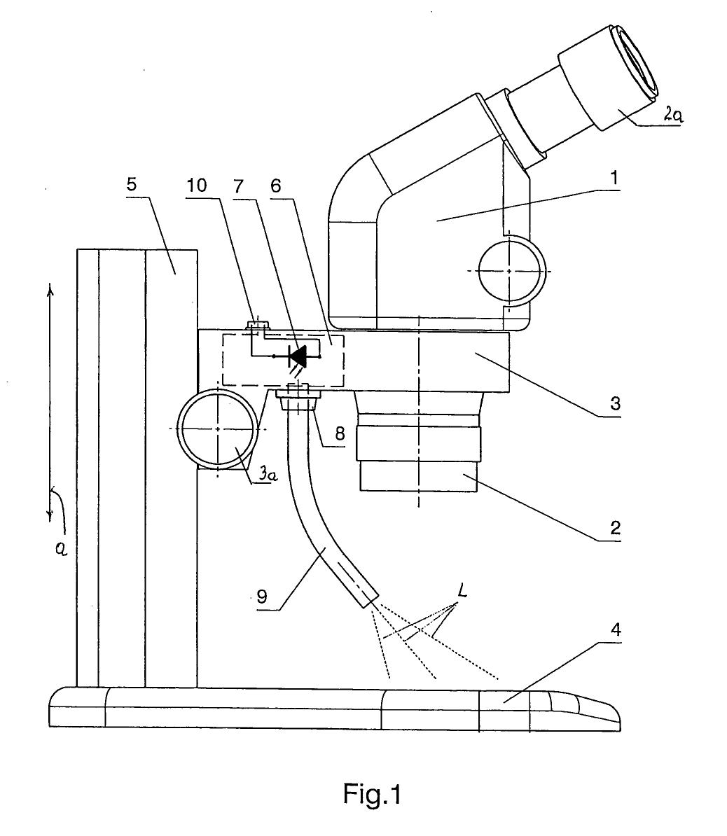

In FIG. 1, a microscope is shown, which comprises an optical observation system 1 having an objective 2 and an eyepiece 2a. This observation system is supported by a support arm 3, which is adjustable in height (see arrow a) in a known manner by means of an adjustment knob 3a along a substantially vertical microscope pillar 5 that stands on a base plate 4 which may stand on the surface of a working table (not shown). An object to be investigated has to be positioned on the base plate 4 within the visual field of the objective 2.

For illuminating such object, an electric light-source integrated into the support arm 3 is provided. To this end, a cavity 6, shown in interrupted lines, is formed within the support arm 3 and is intended to receive and hold, as preferred, a light-diode 7 or a light-diode array.

Those walls which surround the cavity 6 are of a light tight or light impermeable material. At the lower side of the support arm 3, a mechanical, hollow plug-in and holding device in the form of a tip jack 8 which is positioned in the lower wall of the cavity 6 and oriented towards the light emitting surface of the light-diode 7.

As mentioned above, the tip jack 8 is a part of a plug-in and holding system through which the light entry window of a short, preferably flexible, fiber-optical light guide 9 is coupled to the light diode 7. The light exit window of the light guide 9 is directed to the place of the object to be investigated, as is indicated by dotted lines L representing the light beam. If the light guide 9 is a fiber-optic, flexible one, it enables orientation of the light beam L in any desired direction, e.g. for illuminating the object from different heights.

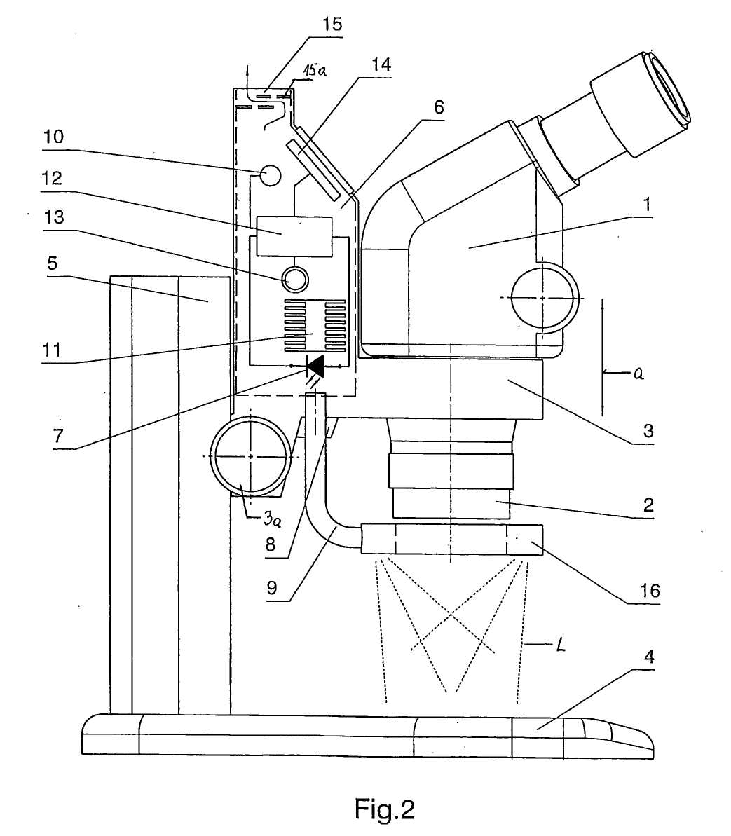

For energizing the light-diode 7 there is another part of the above-mentioned plug-in and holding system, i.e. an electric tip jack 10 to be connected either to an outer electricity supply system or to connect an internal electricity supply and control system in the cavity with the mains. Likewise as the walls which surround the cavity 6, the plug-in and holding system, which comprises the tip jacks 8 and 10, too, is light tight so as to avoid radiation of scattered light from the cavity 6. Suitably, the cavity 6 and the electric current consuming components contained in it are actively cooled, which is not shown in FIG. 1, but shall now be described with reference to the embodiments of FIGS. 2, 3 and 5.

In FIGS. 2 to 5, parts, which correspond to parts of FIG. 1, have the same reference signs. According to FIG. 2, the relative large cavity 6 is arranged on the support arm 3 between the observation system 1 and the microscope pillar 5. The support arm 3 has an about L-shaped cross-section so as to extend substantially over the height of the observation system 1. In this way, a sufficiently large cavity 6 is provided to integrate and incorporate all components and units of the illumination device within the microscope.

The light source, i.e. the light-diode 7 or a light-diode array, is mounted on a cooling body 11 having cooling ribs as shown. The light guide 9 is directed to the light-diode 7 through the tip jack 8. In this case, the light guide is a rigid one and guides the light of the light-diode 7 to a fiber-optical ring light 16, which is positioned around and below the objective 2 of the observation system 1 to direct light beams L in an annular shape towards the place of the object to be investigated.

In the cavity of FIG. 2, there is, moreover, a power supply and control stage 12 for the light-diode 7 and supplies direct current necessary for operating the light-diode 7. A handle 13 is provided to enable adjustment of parameters, such as light intensity and/or light color of the light-diode 7, whereas a display 14 is to monitor and show the parameters chosen. Energy supply to the power supply and control stage 12 from the mains is effected via the tip jack 10.

At the top of the cavity 6, an air exit or ventilation aperture 15 is situated, and lamellae 15a, arranged in a labyrinth-like manner, allow the exit of air heated up in the cavity and the access of (cooler) ambient air, while preventing the transmission of light. The cavity 6 of FIG. 2 may be manufactured as a light-tight housing, which in the procedure of manufacturing the microscope, in the final stage, is fastened to the support arm 3 in a light-tight manner, e.g. by screwing or by a manually releasable holding device so that it forms a one-piece with the microscope.

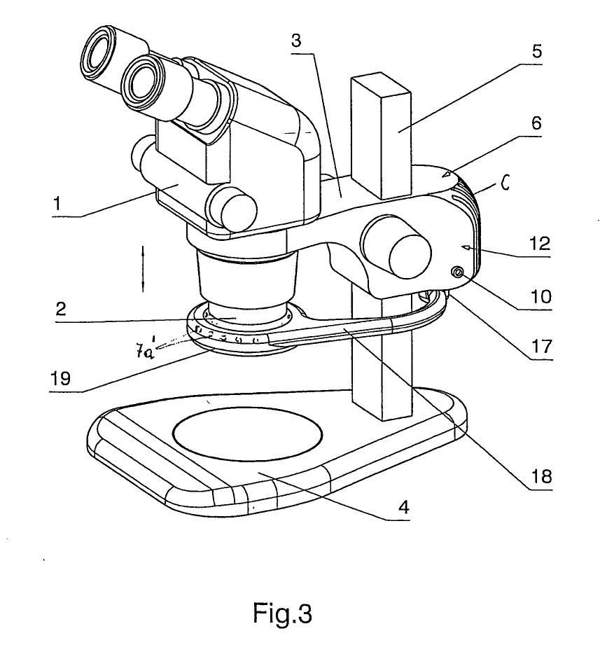

In the embodiment of FIG. 3, the support arm 3 extends, in contrast to the embodiments of FIGS. 1 and 2, up to behind the microscope pillar 5, so that the cavity 6 can be arranged there (reference numeral 6 is directed to the upper wall, which covers the cavity), in the rearward region of the support arm 3 on that end which is opposite the end which supports the observation system 2, 2a. In the cavity 6 an energy supply and control stage 12 is accommodated, as is indicated by the respective reference numeral 12. This stage 12 supplies energy to light-diodes 7a′ arranged on an annular holder 19 to form a ring light. This annular holder 19 is born by an arm 18 which is plugged into a plug-in and holding system 17 at the rear lower wall of the support arm. Via the plug-in system 17 electrical connection to the stage 12 is realized so that an inner conductor device (not shown) in the arm 18 supplies energy to the light-diodes 7a′. The rearward portion of the supply arm is suitably provided with cooling ribs C to improve heat dissipation from the cavity 6.

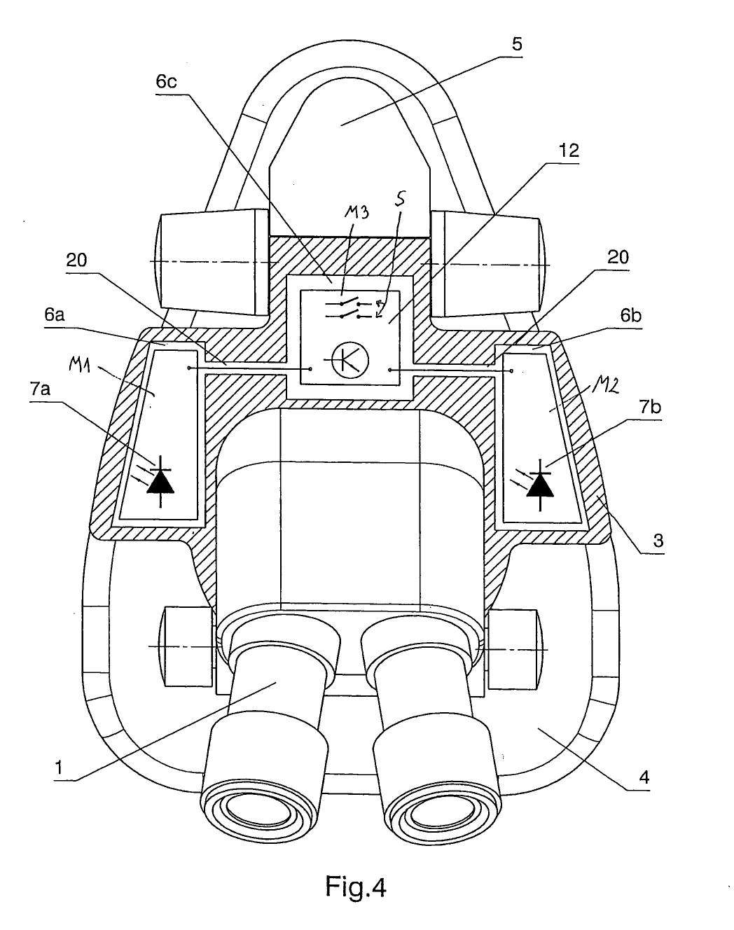

In the plan view according to FIG. 4, it is only the support arm 3 for the observation system 1 is visible in a cross-sectional view. The support arm 3, in comparison with the previous embodiments, is formed in such a manner that it extends to both sides of the microscope pillar 5. In the support arm 3, there are three separated cavities 6a, 6b, 6c. For example, cavity 6a may house a light-diode (or a diode array) 7a, which emits white light, whereas in cavity 6b is a light-diode (or diode array) 7b which emits colored light. Energy supply to the light-diodes 7a, 7b is effected by the energy supply and control stage 12 accommodated in cavity 7c. For the connection of the stage 12 to the cavities 7a and 7b, there are channels 20 through which respective conductors are led, as shown in FIG. 4.

For each of the cavities 6a and 6b, equipped with the light-diodes 7a and 7b, a plug-in and holding system for appropriate light guides are provided, which are not visible in FIG. 4, but are similar to those shown in FIG. 1. The control stage 12 is provided with switches S which enable selective operation of the light-diodes 7a and/or 7b. To this end, there are knobs or the like, through which the user can actuate one or both of the switches S from outside the cavity 6c. For an general investigation of an object, one would choose white light, whereas for a fluorescence examination one would choose colored light. However, it is also possible that diodes of identical color temperature are used as the light-diodes 7a, 7b, so that an illumination of the object with higher light intensity and/or from different directions is made possible. In order to achieve a higher variability, the components 7a, 7b, 12 are suitably formed as easily exchangeable modules M1 to M3.

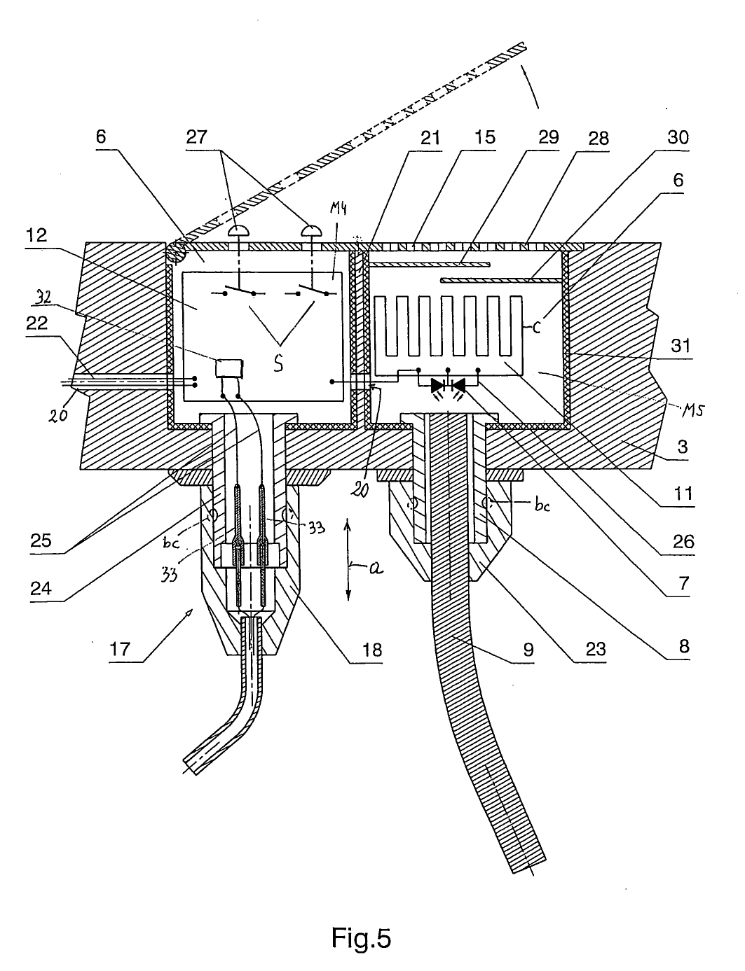

How en exchange can be made in a simple manner is now described with reference to FIG. 5. In this embodiment, the cavity 6 is subdivided by a partition 21 which has a channel 20, like in the embodiment of FIG. 4 in order to accommodate a conductor(s) 26. In this way, a greater length of the relative thin support arm can be utilized to accommodate one component after the other. In one of the thus formed sub-cavities 6 is a double light-diode 7 together with the cooling ribs C of a cooling body 11, whereas in the other cavity is the energy supply and control stage 12. This energy supply and control stage 12 receives power through the wires 22 (left side of FIG. 5). The light-diodes 7 are connected to this stage via the conductor 26. In a similar way as in the embodiment of FIG. 4, two switches S are provided to be actuated by key buttons 27 to alter light intensity and or color temperature of the light-diodes 7. Furthermore, the control stage 12 (but also the light-diodes 7, if desired) can be provided with a cooling device, which is suitably a Peltier element 32.

In order to couple a light guide 9 for illuminating an object in a similar manner as in FIG. 1 or in FIG. 2, the tip jack 8 is arranged in the lower wall which delimits the cavity 6, and is oriented towards the light-diodes 7. For the connection, the light guide 9 has a sleeve-like socket 23, which makes it possible to simply plug it onto the tip jack 8. A ball catch bc secures the plug-in connection against unintentional disconnecting, but permits turning the socket 23 and the light guide 9 when the object has to be illuminated from a different side.

On the other hand, there is an electrical tip jack 24 for mechanically and electrically coupling and supplying a ring light (as in FIG. 3) or even of an external light source, such as a light-diode beam projector, is provided in the lower wall of the cavity 6, below the energy supply and control stage 12. The electric contacts 33 of the tip jack 24 are connected to the stage 12 (which in turn receives external power over tip jack 10 of FIG. 1). To this tip jack 24, an arm 18 (FIG. 3, 5) for a ring light 19 may be connected, the arm 18 having a socket, in a similar way as the socket 23, to be plugged over the tip jack 24.

Therefore, also this plug-in and holding connection 18, 24 has a ball catch bc, to prevent unintentional removal of the arm 18. However, instead of the arm 18, it is possible to connect a connector for supplying an external light source, such as a diode light projector separated from the microscope.

The combined cavity 6, at its top, is closed by a pivoting flap 28. This flap 28 has ventilation apertures 15 to enable heat from the cavities, and especially from the diodes 7, to escape. However, in order to avoid exit of light through the apertures 15, there are lamellae 29,30 which are off-set to one another in a labyrinth-like manner, just so to enable heated air to pass through them. In some cases, a single lamella might do. It may be noted that a similar arrangement could be provided at the lower side of the support arm in order to ensure efficient supply of ambient (cool) air.

Lining the inner walls of one or all cavities 6, 6a, 6b, 6c with a thermal insulating material 31 reduces further the risk of the support arm 3 of heating up. As has already been mentioned, a Peltier element 32 or any other cooling device can also be foreseen.

Integration of an illumination device into the support arm 3 for an observation system 1 is especially suited for epi-illumination or vertical illumination of objects, particularly if a stereo-microscope is used. As has already been mentioned, the components are suitably formed as, e.g. one-piece, modules, such as M4 and M5 in FIG. 5, wherein module M5 consist merely of the cooling body 11 and the diodes 7. In this way, the respective module can easily be removed without the necessity of using a tool in a similar way as it is with the exchange of printed circuits, which usually have guides to be appropriately inserted into a housing where slide contacts provide the electrical connection. Such guides would also provide for a correct orientation of the light-sources or light-diodes 7, 7a, 7b onto the light guide 9.

What is claimed is:

1. A microscope comprising
a microscope basis for placing the microscope onto a surface;
a microscope pillar standing on said microscope basis and extending substantially in upright direction;
an optical system for observing an object;
an illumination system for illuminating said object, said illumination system including
at least one component operated by electric current, and
at least one energy guiding means for guiding energy towards said object;
support arm means on said microscope pillar and projecting from it in a certain height above said microscope basis and over a predetermined length, said support arm means supporting at least part of said optical system, the support arm means including
substantially light-tight wall means surrounding at least one cavity in said support arm means, said cavity being located between said optical system and a region that is at least near said microscope pillar, wherein said at least one component is located within said cavity and comprises said internal light source, and
plug-in and holding means for said energy guiding means;
adjusting means for adjusting said height along said microscope pillar.

2. Microscope as claimed in claim 1, wherein said illumination system comprises an external light source for directing light onto said object, said energy guiding means comprising conductor means connectable to said plug-in and holding means for supplying electrical energy to said external light source.

3. Microscope as claimed in claim 1, wherein said component is formed as exchangeable module, which is able to be inserted into said cavity.

4. Microscope as claimed in claim 1, wherein said wall means comprise a cover formed to assume an open position and a closed position.

5. Microscope as claimed in claim 1, wherein said cavity on said support arm means is remote from said optical system.

6. Microscope as claimed in claim 1, further comprising thermal insulating means for insulating said at least one cavity.

7. Microscope as claimed in claim 1, wherein said wall means comprise at least one ventilation aperture.

8. Microscope as claimed in claim 1, further comprising cooling means in said at least one cavity.

9. Microscope as claimed in claim 8, wherein said at least one cavity comprises at least one Peltier element.

10. A microscope comprising
a microscope basis for placing the microscope onto a surface;
a microscope pillar standing on said microscope basis and extending substantially in upright direction;
an optical system for observing an object;
an illumination system for illuminating said object, said illumination system including
at least one component operated by electric current,
at least one internal light source and
at least one light guide for guiding the light of said internal light source towards said object;
support arm means on said microscope pillar and projecting from it in a certain height above said microscope basis and over a predetermined length, said support arm means supporting at least part of said optical system, the support arm means including
substantially light-tight wall means surrounding at least one cavity in said support arm means, said cavity being located between said optical system and a region that is at least near said microscope pillar, wherein said at least one component is located within said cavity and comprises said internal light source, and
plug-in and holding means for said light guide;
adjusting means for adjusting said height along said microscope pillar.

11. Microscope as claimed in claim 10, wherein said wall means surround at least two cavities, one cavity housing one of said at least one internal light source, whereas the other cavity houses en electric component.

12. Microscope as claimed in claim 10, further comprising channel means extending between said at least two cavities and housing at least one electrical conductor for inter-connecting components housed in said cavities.

13. Microscope as claimed in claim 10, wherein said internal light source comprises at least one light diode.

14. Microscope as claimed in claim 10, wherein said light guide means is flexible to be oriented towards said object.

15. Microscope as claimed in claim 8, wherein that wall means, which surround a cavity containing said internal light source comprise at least one ventilation aperture.

16. Microscope as claimed in claim 15, further comprising at least one covering lamella for shielding said ventilation aperture against any passage of light from said at least one internal light source, but enabling the escape of heat in said cavity.

17. A microscope comprising
a microscope basis for placing the microscope onto a surface;
a microscope pillar standing on said microscope basis and extending substantially in upright direction;
an optical system for observing an object;
an illumination system for illuminating said object, said illumination system including
at least one component operated by electric current, and
at least one energy guiding means for guiding energy towards said object;
support arm means on said microscope pillar and projecting from it in a certain height above said microscope basis and over a predetermined length, said support arm means supporting at least part of said optical system, the support arm means including
substantially light-tight wall means surrounding at least one cavity in said support arm means, said cavity being located between said optical system and a region that is at least near said microscope pillar, wherein said at least one component is located within said cavity and comprises said internal light source, and
plug-in and holding means for said energy guiding means;
adjusting means for adjusting said height along said microscope pillar the illumination system comprising varying means to be actuated from outside said support arm means for actuating at least one electric component within said at least one cavity for varying the illumination.
